(19) United States
(12) Patent Application Publication
(10) Pub. No.: US 2008/0155305 A1
(43) Pub. Date: Jun. 26, 2008

(54) COLLABORATIVE PROBLEM DETERMINATION BASED ON GRAPH VISUALIZATION

(75) Inventors: John R. Hind, Raleigh, NC (US); Ronald Patrick Doyle, Raleigh, NC (US); Yongcheng Li, Cary, NC (US); Heng Chu, Chapel Hill, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/615,047

(22) Filed: Dec. 22, 2006

(51) Int. Cl. G06F 11/07

(52) U.S. Cl. 714/2; 714/E11.023

(57) ABSTRACT

Mapping an application configuration, a network configuration, or both, into a problem/symptom space defining a graphical user interface so as to facilitate problem determination and resolution. Information retrieved from a knowledge base is incorporated into a graphical user interface. The knowledge base stores data pertaining to one or more symptoms of a problem, relationships of symptoms, and actions to be taken for solving the problem. The graphical user interface includes a symptom layer, a collecting layer, and a correcting layer. One or more symptoms are displayed in the symptom layer. One or more symptoms are selected from the graphical user interface. Data are gathered, analyzed, and displayed in the collecting layer in response to the selected one or more symptoms. One or more possible causes are determined for the symptoms. One or more recommended actions to be performed are determined based upon the one or more possible causes. The one or more possible causes and one or more recommended actions are displayed in the correcting layer. A determination is formulated as to whether or not the problem is resolved in response to performance of the one or more recommended actions.

### CROSS-REFERENCE TO RELATED APPLICATIONS

This application contains subject matter, which is related to the subject matter of the following co-pending applications, each of which is assigned to the same assignee as this application, International Business Machines Corporation of Armonk, N.Y. Each of the below listed applications is hereby incorporated herein by reference in its entirety: US2005/0283451 filed on Jun. 18, 2004 and entitled, “Method, System and Article of Manufacture for Facilitating Problem Resolution”.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to data processing systems and, more specifically, to methods, apparatuses, and computer program products for facilitating resolution of problems in data processing systems.

2. Description of Background

Problem determination is especially difficult in the context of complex information technology (IT) data processing systems. Such systems typically contain a multiplicity of network-connected servers each executing one or more distributed applications. Existing machine-executable methods do not adequately address problem determination in the context of heterogenous distributed IT data processing systems. For example, some existing software products offer basic problem determination utilities such as logging and troubleshooting, but these products are not well suited for the diagnosis of problems in distributed IT environments. Other existing software products provide integrated distributed system monitoring and management, but a very limited set of capabilities is directed to problem determination. The problem determination capabilities of existing software products are inadequate because the procedures executed by these products fails to consider the specific characteristics of unique user environments. Additionally, these software products fail to integrate inputs from a variety of sources such as customers, customer support personnel, software developers, and other individuals who may be involved in the problem determination process. What is needed is a problem determination technique, which considers the specific characteristics of unique user environments and accepts inputs from a plurality of different sources.

### SUMMARY OF THE INVENTION

The shortcomings of the prior art are overcome and additional advantages are provided by a method for mapping an application configuration, a network configuration, or both, into a problem/symptom space defining a graphical user interface so as to facilitate problem determination and resolution. The method comprises incorporating into a graphical user interface information retrieved from a knowledge base that stores data pertaining to one or more symptoms of a problem, relationships of symptoms, and actions to be taken for solving the problem. The graphical user interface includes a symptom layer, a collecting layer, and a correcting layer. One or more symptoms are displayed in the symptom layer. One or more symptoms are selected from the graphical user interface. Data are gathered, analyzed, and displayed in the collecting layer in response to the selected one or more symptoms. One or more possible causes are determined for the symptoms. One or more recommended actions to be performed are determined based upon the one or more possible causes. The one or more possible causes and one or more recommended actions are displayed in the correcting layer. A determination is formulated as to whether or not the problem is resolved in response to performance of the one or more recommended actions. If the problem is not resolved, then the foregoing process is iteratively performed by gathering, analyzing, and displaying data, determining one or more possible causes for the symptoms, determining one or more recommended actions to be performed, and displaying the one or more possible causes and one or more recommended actions until the problem is resolved.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution wherein application configuration data, or network configuration data, or both, are mapped into a problem/symptom space defining a graphical user interface so as to facilitate problem determination and resolution.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary generalized graphical user interface incorporating information pertaining to problems or symptoms, relationships of problems or symptoms, and actions to be taken for solving the problems or symptoms.

FIG. 2 shows a first illustrative example by which the graphical user interface of FIG. 1 may be employed to visualize a problem determination process.

FIG. 3 shows a second illustrative example by which the graphical user interface of FIG. 1 may be employed to visualize a problem determination process.

Like reference numerals are used to refer to like elements throughout the drawings. The detailed description explains the preferred embodiments of the invention, together with advantages and features, by way of example with reference to the drawings.

### DETAILED DESCRIPTION OF THE INVENTION

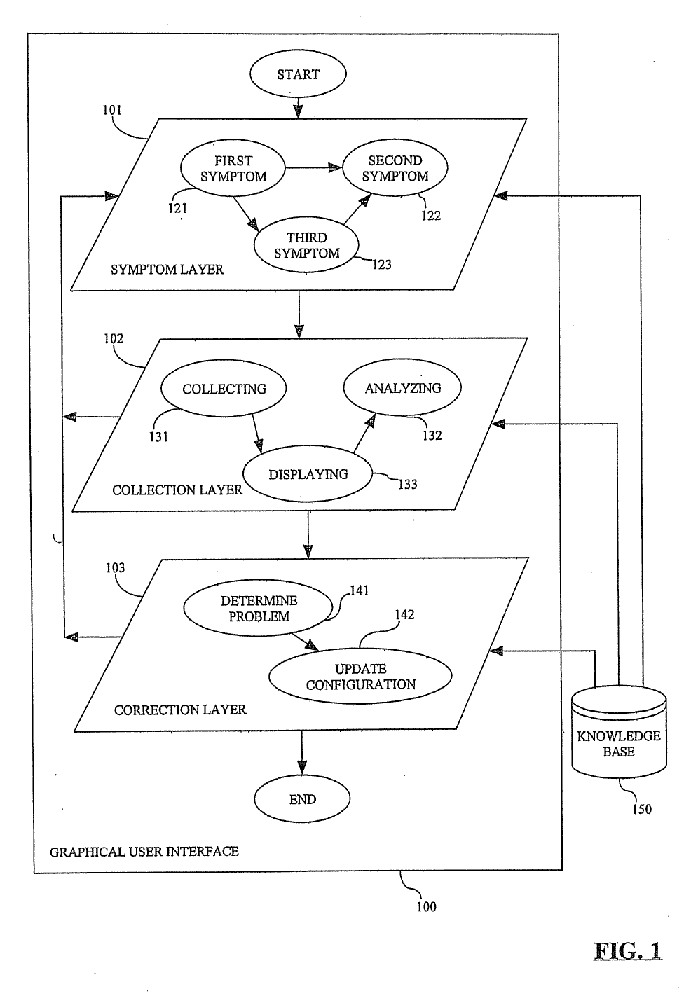

FIG. 1 illustrates an exemplary generalized graphical user interface 100 for visualizing a problem determination process. Information pertaining to problems or symptoms, relationships of problems or symptoms, and actions to be taken for solving the problems or symptoms is stored in a knowledge base 150. Illustratively, knowledge base 150 is implemented using a computer-readable data storage medium such as one or more disk drives, magnetic storage drives, optical storage media, semiconductor memory, or various combinations thereof. Information retrieved from knowledge base 150 is incorporated into a graphical user interface 100 as will be described in greater detail hereinafter.

Graphical user interface 100 provides a graphical depiction of a problem determination process by displaying interrelationships among one or more symptoms of a problem, information that can be collected, displayed or analyzed to aid in diagnosing the problem, possible actions for further diagnosing or correcting the problem, and possible configuration updates. In practice, a different template may be provided for each of a plurality of different problem determination environments and scenarios. However, a typical graphical user interface 100 may be organized into three layers: a symptom layer 101, a collection layer 102, and a correction layer 103. Symptom layer 101 displays one or more symptoms of a problem, such as a first symptom 121, a second symptom 122, and a third symptom 123, showing interrelationships among these symptoms using lines and arrows.

Based upon the symptom or symptom users have observed, subsequent data collection and analysis can be performed, leading to a layer of collecting-displaying-analyzing depicted in graphical user interface 100 as collection layer 102. More specifically, collection layer 102 may display information pertaining to collecting 131, displaying 133, and analyzing 132. Interrelationships among collecting 131, displaying 133, and analyzing 132 may be indicated using lines and arrows.

When enough clues have been collected in collection layer 102, users can advance to a problem fixing layer where the cause of the problem is determined and certain update actions are carried out. This layer is depicted in graphical user interface 100 as correction layer 103. Illustratively, correction layer 103 displays information relating to determining the problem (determine problem 141) and updating a configuration (update configuration 142). Update configuration 142 displays a proposed hardware or software configuration update for resolving the problem, or for facilitating further problem determination. Interrelationships among items shown in correction layer 103, such as determine problem 141 and update configuration 142, may be shown using lines and arrows. Optionally, multiple iterations may take place between symptom layer 101, collection layer 102, and correction layer 103.

In operation, users improve and enhance a problem determination process through graphical user interface 100. Users can manipulate graphical user interface 100 by adding items, removing items, editing items, changing item-to-item links, or various combinations thereof. These manipulations can be performed with respect to items displayed in any of symptom layer 101, collection layer 102, or correction layer 103. In this manner, graphical user interface 100 may be customized for a given environment or rendered more accurate for a given system application.

Users may include customers, support personnel, or developers who interact with graphical user interface 100 to navigate through a problem determination process. These users may take action against a system exhibiting a problem by collecting data or updating the configuration of the system. Users may also modify the problem determination process depicted in graphical user interface 100 as discussed previously, or contribute automated scripts to graphical user interface 100 for automatic task execution.

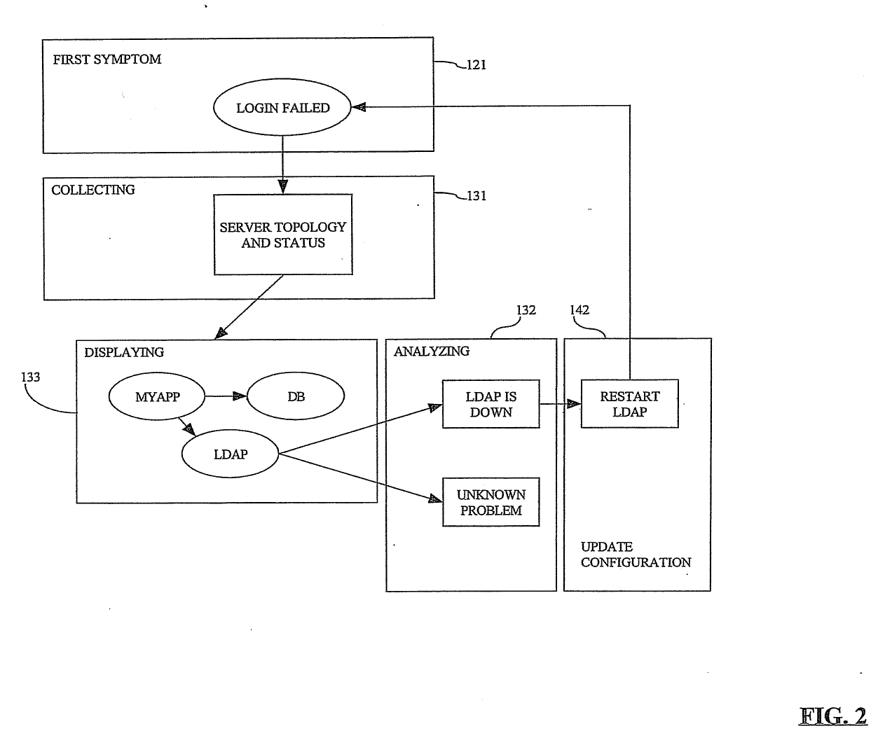

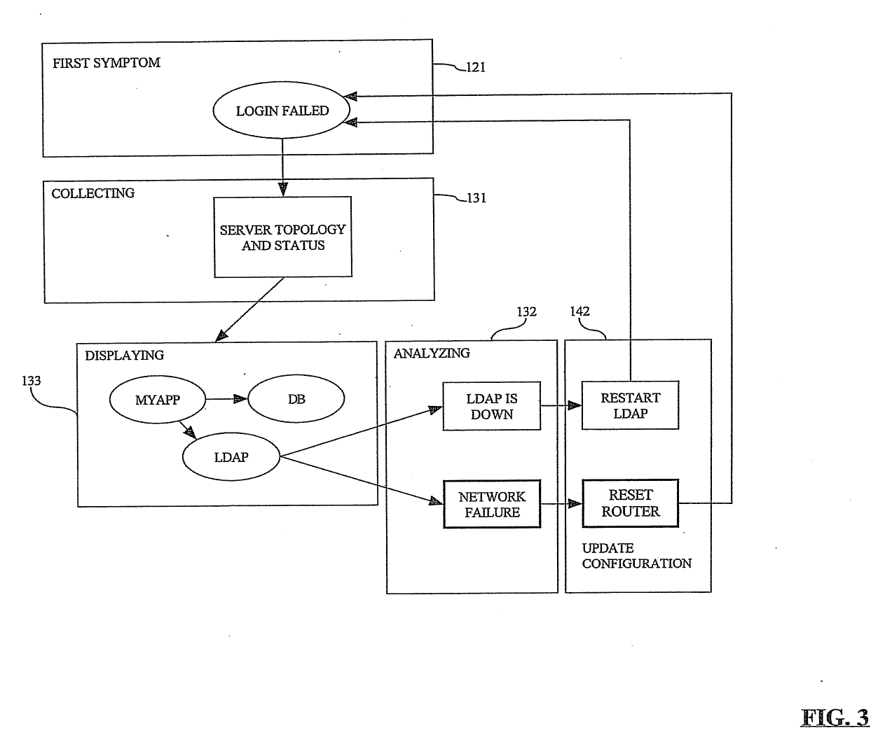

FIGS. 2 and 3 present illustrative examples for visualizing a problem determination process mapped onto the symptom layer 101, collection layer 102, and correction layer shown in FIG. 1. The illustrative examples of FIGS. 2 and 3 demonstrate that graphical user interface 100 (FIG. 1) can be employed to enhance the problem determination process by means of a user adding additional branches to the collecting 131-displaying 133-analyzing 132 paths of collection layer 102. Referring to FIG. 2, assume that a user experiences a first symptom 121 of log-in failure. The log-in failure symptom is mapped to analyzing 132 path where failure of a lightweight directory access protocol (LDAP) server is identified as a possible cause for the symptom. This mapping occurs because knowledge base 150 (FIG. 1) includes knowledge from past problem determination processes suggesting that the LDAP server could be down and a server restart should be performed.

For purposes of the present example, assume that the user attempts to restart the LDAP server but the server will not execute the restart command. Further diagnosis reached by mapping first symptom 121 to collection layer 102 reveals that a network device may be down. Accordingly, the user adds a new rule of “network down, therefore reset router” to the problem determination process via manipulation of graphical user interface 100. The user-modified graphical user interface is shown in FIG. 3. The user has added a possible cause of “network failure” to analyzing 132 path, and this path leads to a possible problem resolution in configuration 142 path of restarting a router. If restarting the router still does not solve the problem, further iterations may occur whereby one or more users add, remove, or edit items from graphical user interface 100 (FIG. 1) to modify the problem determination mapping included therein. Changes made by users to graphical user interface 100 may be stored in knowledge base 150 to be shared with other users.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of mapping an application configuration, a network configuration, or both, into a problem/symptom space defining a graphical user interface so as to facilitate problem determination and resolution, the method comprising:
incorporating into a graphical user interface information retrieved from a knowledge base that stores data pertaining to one or more symptoms of a problem, relationships of symptoms, and actions to be taken for solving the problem, wherein the graphical user interface includes a symptom layer, a collecting layer, and a correcting layer;
displaying one or more symptoms in the symptom layer;
selecting one or more symptoms from the graphical user interface;
gathering, analyzing, and displaying data in the collecting layer in response to the selected one or more symptoms;
determining one or more possible causes for the symptoms;
determining one or more recommended actions to be performed based upon the one or more possible causes;
displaying the one or more possible causes and one or more recommended actions in the correcting layer;
determining whether or not the problem is resolved in response to performance of the one or more recommended actions;
if the problem is not resolved, iteratively gathering, analyzing, and displaying data, determining one or more possible causes for the symptoms, determining one or more recommended actions to be performed, and displaying the one or more possible causes and one or more recommended actions until the problem is resolved.

2. The method of claim 1 further including:
receiving a user modification which adds, removes, or edits at least one item displayed in the symptom layer, the collection layer, or the correction layer, and
incorporating the user modification into the graphical user interface.

3. The method of claim 1 further including:
receiving a user modification which modifies a relationship between two or more items displayed in any of the symptom layer, the collection layer, or the correction layer, and
incorporating the user modification into the graphical user interface.

4. The method of claim 1 wherein the correcting layer displays one or more update actions to be performed.

5. A computer program product for mapping an application configuration, a network configuration, or both, into a problem/symptom space defining a graphical user interface so as to facilitate problem determination and resolution, the computer program product comprising a storage medium readable by a processing circuit and storing instructions for execution by the processing circuit for facilitating a method comprising:
incorporating into a graphical user interface information retrieved from a knowledge base that stores data pertaining to one or more symptoms of a problem, relationships of symptoms, and actions to be taken for solving the problem, wherein the graphical user interface includes a symptom layer, a collecting layer, and a correcting layer;
displaying one or more symptoms in the symptom layer;
selecting one or more symptoms from the graphical user interface;
gathering, analyzing, and displaying data in the collecting layer in response to the selected one or more symptoms;
determining one or more possible causes for the symptoms;
determining one or more recommended actions to be performed based upon the one or more possible causes;
displaying the one or more possible causes and one or more recommended actions in the correcting layer;
determining whether or not the problem is resolved in response to performance of the one or more recommended actions;
if the problem is not resolved, iteratively gathering, analyzing, and displaying data, determining one or more possible causes for the symptoms, determining one or more recommended actions to be performed, and displaying the one or more possible causes and one or more recommended actions until the problem is resolved.

6. The computer program product of claim 5 further including instructions for:
receiving a user modification which adds, removes, or edits at least one item displayed in the symptom layer, the collection layer, or the correction layer, and
incorporating the user modification into the graphical user interface.

7. The computer program product of claim 5 further including instructions for:
receiving a user modification which modifies a relationship between two or more items displayed in any of the symptom layer, the collection layer, or the correction layer, and
incorporating the user modification into the graphical user interface.

8. The computer program product of claim 1 wherein the correcting layer displays one or more update actions to be performed.
